(19) United States
(12) Patent Application Publication
(10) Pub. No.: US 2004/0148635 A1
(43) Pub. Date: Jul. 29, 2004

(54) Audio and video stream integrating platform and method for allowing websites to stream audio and video from at least one camera to multiple viewers simultaneously over the internet without excessive infrastructure

(76) Inventor: Riaz Merchant, Miami, FL (US)

Correspondence Address: CHARLES E. BAXLEY, ESQUIRE, 59 John Street, Fifth Floor, New York, NY, 10038, US

(21) Appl. No.: 10/354,418

(22) Filed: Jan. 29, 2003

(51) Int. Cl. H04N 7/173; H04N 7/16; H04N 7/14; H04N 7/18; G06F 15/16; H04N 9/47

(52) U.S. Cl. 725/109; 725/110; 725/95; 725/25; 725/30; 348/143; 709/217; 709/218; 348/14.01; 348/14.03; 348/14.12

(57) ABSTRACT

A content provider has a server allowing streaming of audio and video from at least one camera to multiple viewers simultaneously over the Internet, and a service provider has a website. The content provider delivers instructions to the service provider on how to integrate the website with the server in response to signing up therewith. The service provider allows a user to stream audio and video from at least one camera to multiple viewers simultaneously over the Internet through the website in response to setting up a camera account therewith and becoming a camera account holder. The service provider is integrated with the server in such a way so as offer the audio and video streaming service through the website that allows the user and the multiple viewers to get the impression that the audio and video streaming service is hosted from the website when in reality it is hosted from the server therefore making the audio and video streaming service transparent of the content provider.

### BACKGROUND OF THE INVENTION

1. Field of the Invention

The present invention relates to an audio and video streaming platform and method. More particularly, the present invention relates to an audio and video streaming platform and method for allowing a user to stream audio and video from at least one camera to multiple viewers simultaneously over the Internet.

2. Description of the Prior Art

Numerous innovations for Internet systems have been provided in the prior art. Even though these innovations may be suitable for the specific individual purposes to which they address, they each differ in structure and/or operation and/or purpose from the present invention and would therefore not be suitable for the purposes of the present invention as heretofore described.

### SUMMARY OF THE INVENTION

ACCORDINGLY, AN OBJECT of the present invention is to provide an audio and video streaming platform and method for allowing a user to stream audio and video from at least one camera to multiple viewers simultaneously over the Internet that avoids the disadvantages of the prior art.

ANOTHER OBJECT of the present invention is to provide an audio and video streaming platform and method for allowing a user to stream audio and video from at least one camera to multiple viewers simultaneously over the Internet that is simple to use.

STILL ANOTHER OBJECT of the present invention is to provide an audio and video streaming platform and method for allowing a user to stream audio and video from at least one camera to multiple viewers simultaneously over the Internet that allows any company to integrate the audio and video streaming platform into their website without a need for developing expensive networking infrastructure.

YET ANOTHER OBJECT of the present invention is to provide an audio and video streaming platform and method for allowing a user to stream audio and video from at least one camera to multiple viewers simultaneously over the Internet that uses low network bandwidth, which means that even users with slow Internet connections can use the audio and video platform without problems.

STILL YET ANOTHER OBJECT of the present invention is to provide an audio and video streaming platform and method for allowing a user to stream audio and video from at least one camera to multiple viewers simultaneously over the Internet that eliminates a need for expensive servers and bandwidth for hosting the service.

YET STILL ANOTHER OBJECT of the present invention is to provide an audio and video streaming platform and method for a user to stream audio and video from at least one camera to multiple viewers simultaneously over the internet that allows the cameras to be selectively operated.

STILL YET ANOTHER OBJECT of the present invention is to provide an audio and video streaming platform and method for a user to stream audio and video from at least one camera to multiple viewers simultaneously over the internet that allows selection of which cameras go to which customers.

BRIEFLY STATED, YET STILL ANOTHER OBJECT of the present invention is to provide an audio and video streaming platform for allowing a user to stream audio and video from at least one camera to multiple viewers simultaneously over the Internet. The audio and video streaming platform includes a content provider and a service provider. The content provider has a server that allows streaming of audio and video from at least one camera to multiple viewers simultaneously over the Internet, and the service provider has a website. The content provider delivers instructions to the service provider on how to integrate the website of the service provider with the server of the content provider in response to the service provider signing up with the content provider and creating a partner account therewith. The service provider allows the user to stream audio and video from the at least one camera to the multiple viewers simultaneously over the Internet through the website of the service provider so as to form an audio and video streaming service in response to the user setting up a camera account therewith and becoming a camera account holder, once the service provider has been integrated with the server of the content provider. The service provider is integrated with the server of the content provider in such a way so as to allow the service provider to offer the audio and video streaming service through the website of the service provider that allows the user and the multiple viewers to get the impression that the audio and video streaming service is hosted from the website of the service provider when in reality it is hosted from the server of the content provider therefore making the audio and video streaming service transparent of the content provider.

The present invention is an audio and video streaming platform and method that allows individual users, companies, and websites to stream audio and video from any generic camera or collection of cameras to multiple viewers simultaneously over the Internet.

The main innovation behind the present invention is the ability to allow any company to integrate the present invention into their website without a need for developing expensive networking infrastructure. The present invention uses low network bandwidth, which means that even users with slow Internet connections can use the present invention without problems. The present invention eliminates a need for expensive servers and bandwidth for hosting the service.

The present invention can be used in multiple-ways. Individual camera owners can setup personal surveillance, personal video conferencing, and personal web-based broadcasting to multiple viewers with any PC Web Cam; no additional hardware is needed. Partners who want to provide audio and video streaming services through their own website will be able to do so easily without a need to setup a hosting infrastructure or writing complex programs. Corporate customers who want to provide live audio and video broadcast services through their own portal can use the present invention.

The technology behind the present invention is powered by cutting-edge web services. The web-service technology allows the present invention to provide audio and video streaming services to its partners at a significantly reduced cost.

The present invention works in multiple ways. Anyone can use the present invention through a content provider portal. A company can integrate the server of the content provider as a web-service to provide content provider-like service to their own customers with their own branding. A company can use the present invention to build their own audio and video streaming portal for their own customers or partners.

The present invention's open architecture allows companies to provide live audio and video streaming services to their customers without investing in expensive infrastructure or going through a complicated process of developing the technology on their own. Businesses can easily offer the services quickly with very easy integration and setup steps.

The novel features which are considered characteristic of the present invention are set forth in the appended claims. The invention itself, however, both as to its construction and its method of operation, together with additional objects and advantages thereof, will be best understood from the following description of the specific embodiments when read and understood in connection with the accompanying drawing.

### BRIEF DESCRIPTION OF THE DRAWING

The figures of the drawing are briefly described as follows:

FIG. 1 is a diagrammatic system diagram of a first embodiment of the audio and video streaming platform of the present invention;

FIGS. 2A-2N are a flow chart of the method for allowing a user to stream audio and video from at least one camera to multiple viewers simultaneously over the Internet utilizing the first embodiment of the audio and video streaming platform shown in FIG. 1;

FIG. 3 is a diagrammatic system diagram of a second embodiment of the audio and video streaming platform of the present invention; and

FIGS. 4A-4M are a flow chart of the method for allowing a user to stream audio and video from at least one camera to multiple viewers simultaneously over the Internet utilizing the second embodiment of the audio and video streaming platform shown in FIG. 3.

### LIST OF REFERENCE NUMERALS UTILIZED IN THE DRAWING

### FIRST EMBODIMENT

10 audio and video streaming platform of present invention for allowing user 12 to stream audio and video from at least one camera 14 to multiple viewers 16 simultaneously over Internet

12 user

14 at least one camera

16 multiple viewers

18 content provider

20 service provider

22 server of content provider 18

24 website of service provider 20

25 instructions on how to integrate website 24 of service provider 20 with server 22 of content provider 18

26 partner account between service provider 20 and content provider 18

28 camera account of user 12

30 camera account holder of camera account 28 of user 12

32 viewer IDs of multiple viewers 16

34 viewer passwords of multiple viewers 16

36 software to connect camera account holder 30 of camera account 28 of user 12 to website 24 of service provider 20

38 location of camera 14 of camera account holder 30 of camera account 28 of user 12

40 connection between viewer 16 and camera 14 of camera account holder 30 of camera account 28 of user 12

42 audio component

44 text-based messages

### SECOND EMBODIMENT

110 audio and video streaming platform of present invention for allowing user 112 to stream audio and video from at least one camera 114 to multiple viewers 116 simultaneously over Internet

112 user

114 at least one camera

116 multiple viewers

118 content provider

124 website of content provider 118

128 camera account of user 112

130 camera account holder of camera account 128 of user 112

132 viewer IDs of multiple viewers 116

134 viewer passwords of multiple viewers 116

136 software to connect camera account holder 130 of camera account 128 of user 112 to website 124 of content provider 118

138 location of camera 114 of camera account holder 130 of camera account 128 of user 112

140 connection between viewer 116 and camera 114 of camera account holder 130 of camera account 128 of user 112

142 audio component

144 text-based messages

### DETAILED DESCRIPTION OF THE INVENTION

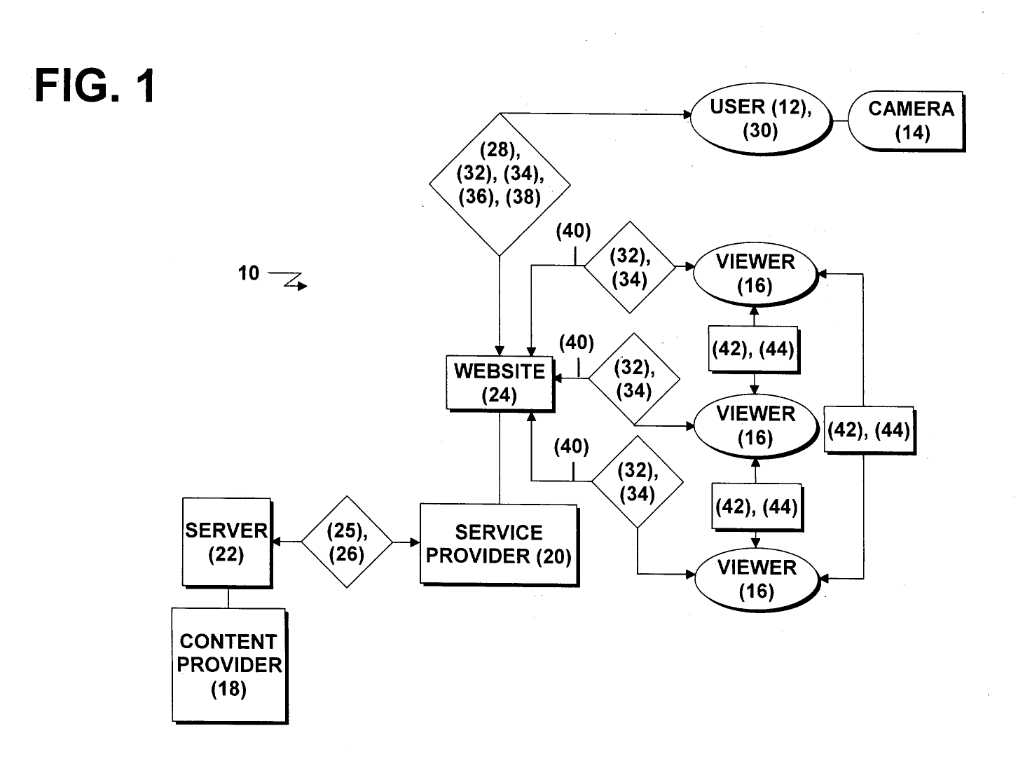

Referring now to the figures, in which like numerals indicate like parts, and particularly to FIG. 1, which is a diagrammatic system diagram of a first embodiment of the audio and video streaming platform of the present invention, a first embodiment of the audio and video streaming platform of the present invention is shown generally at 10 for allowing a user 12 to stream audio and video from at least one camera 14 to multiple viewers 16 simultaneously over the Internet.

The audio and video streaming platform 10 comprises a content provider 18 and a service provider 20. The content provider 18 has a server 22 that allows streaming of audio and video from the at least one camera 14 to the multiple viewers 16 simultaneously over the Internet, and the service provider 20 has a website 24.

The content provider 18 delivers instructions 25 to the service provider 20 on how to integrate the website 24 of the service provider 20 with the server 22 of the content provider 18 in response to the service provider 20 signing up with the content provider 18 and creating a partner account 26 therewith.

The service provider 20 allows the user 12 to stream audio and video from the at least one camera 14 to the multiple viewers 16 simultaneously over the Internet through the website 24 of the service provider 20 so as to form an audio and video streaming service in response to the user 12 setting up a camera account 28 therewith and becoming a camera account holder 30, once the service provider 20 has been integrated with the server 22 of the content provider 18.

The service provider 20 is integrated with the server 22 of the content provider 18 in such a way so as to allow the service provider 20 to offer the audio and video streaming service through the website 24 of the service provider 20 that allows the user 12 and the multiple viewers 16 to get the impression that the audio and video streaming service is hosted from the website 24 of the service provider 20 when in reality it is hosted from the server 22 of the content provider 18 therefore making the audio and video streaming service transparent of the content provider 18.

The camera account 28 of the user 12 is set up on the website 24 of the service provider 20 making the user 12 the camera account holder 30 who creates viewer IDs 32 and viewer passwords 34 and provides them to the multiple viewers 16.

The camera account holder 30 uses software 36 to connect to the website 24 of the service provider 20. The website 24 of the service provider 20 authenticates the camera account holder 30 and does not accept from the camera account holder 30 a location 38 of the camera 14 of the camera account holder 30 if the camera account holder 30 is not authenticated, but does accept from the camera account holder 30 the location 38 of the camera 14 of the camera account holder 30 and allows the camera account holder 30 to start broadcasting if the camera account holder 30 is authenticated.

The multiple viewers 16 log on to the website 24 of the service provider 20 using the viewer IDs 32 and the viewer passwords 34. The website 24 of the service provider 20 authenticates the viewer ID 32 and the viewer password 34 of the viewer 16 and does not establish a connection 40 between the viewer 16 and the camera 14 of the camera account holder 30 if the viewer ID 32 and the viewer password 34 are not authenticated, but does establish the connection 40 between the viewer 16 and the camera 14 of the camera account holder 30 by the service provider 20 posting the location 38 of the camera 14 of the camera account holder 30 to the viewer 16 on the website 24 of the service provider 20 and allowing the viewer 16 to view the streaming audio and video if the viewer ID 32 and the viewer password 34 are authenticated.

The multiple viewers 16 chat with each other, if their connections 40 with the camera 14 of the camera account holder 30 are simultaneous, through an audio component 42 or through text-based messages 44, while simultaneously viewing.

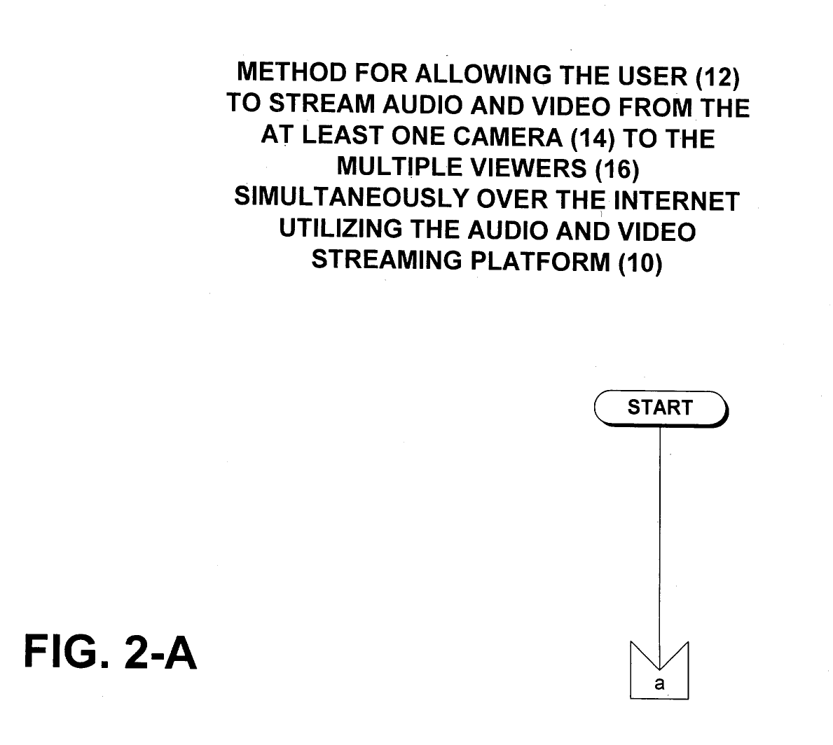

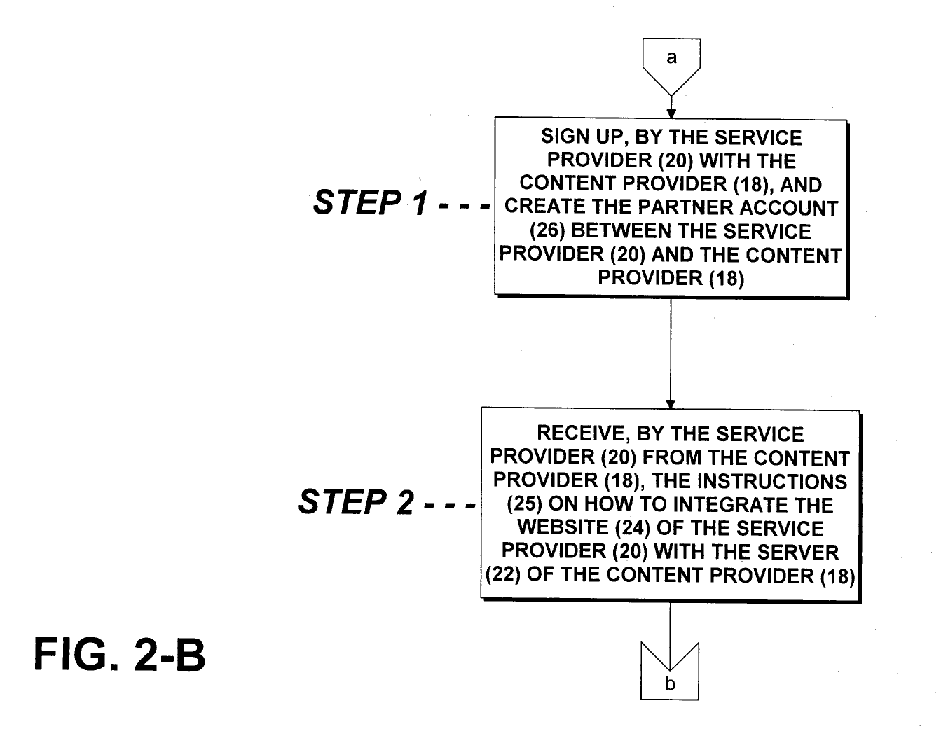

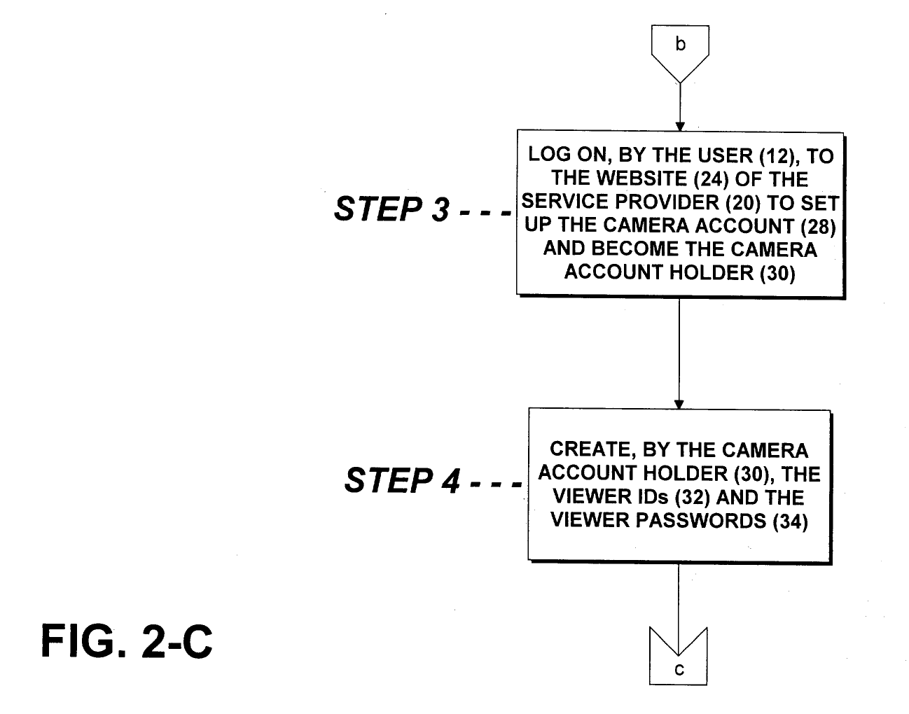

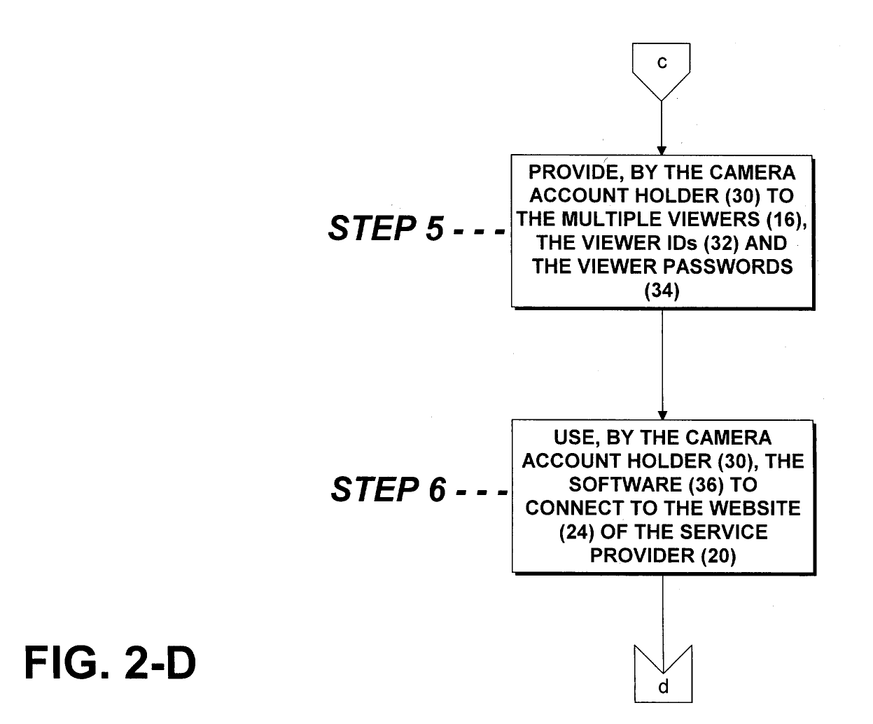

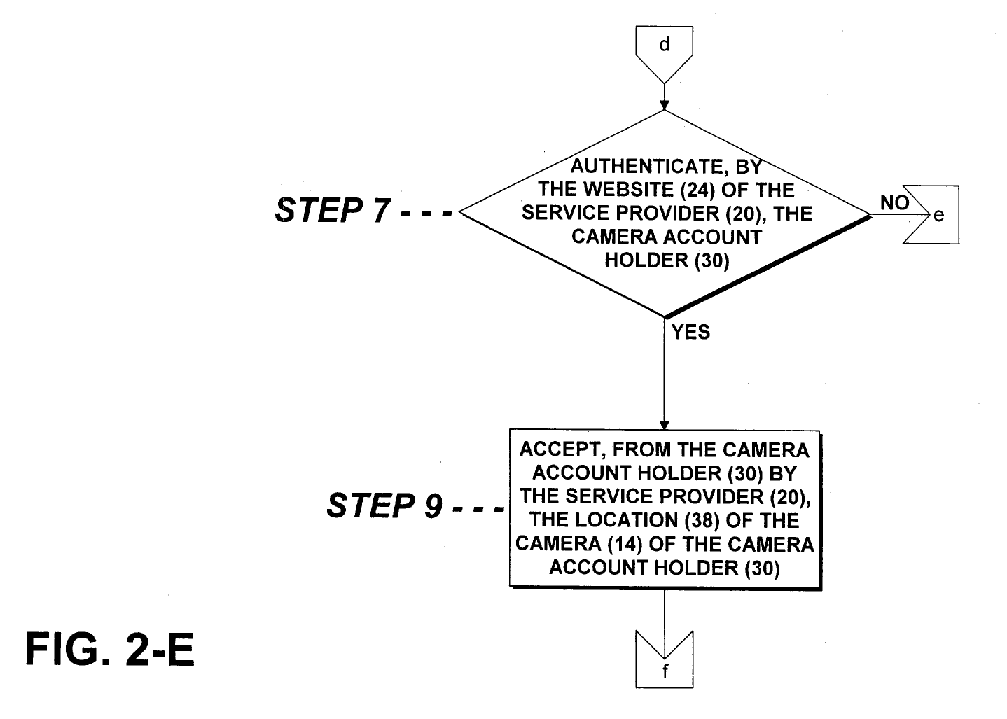

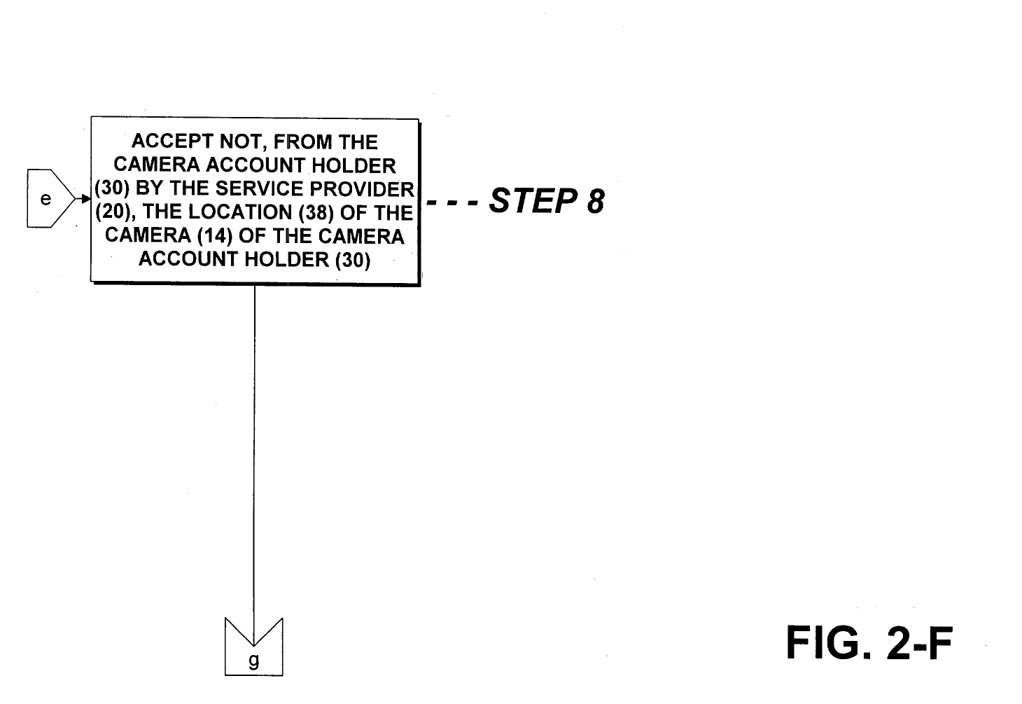

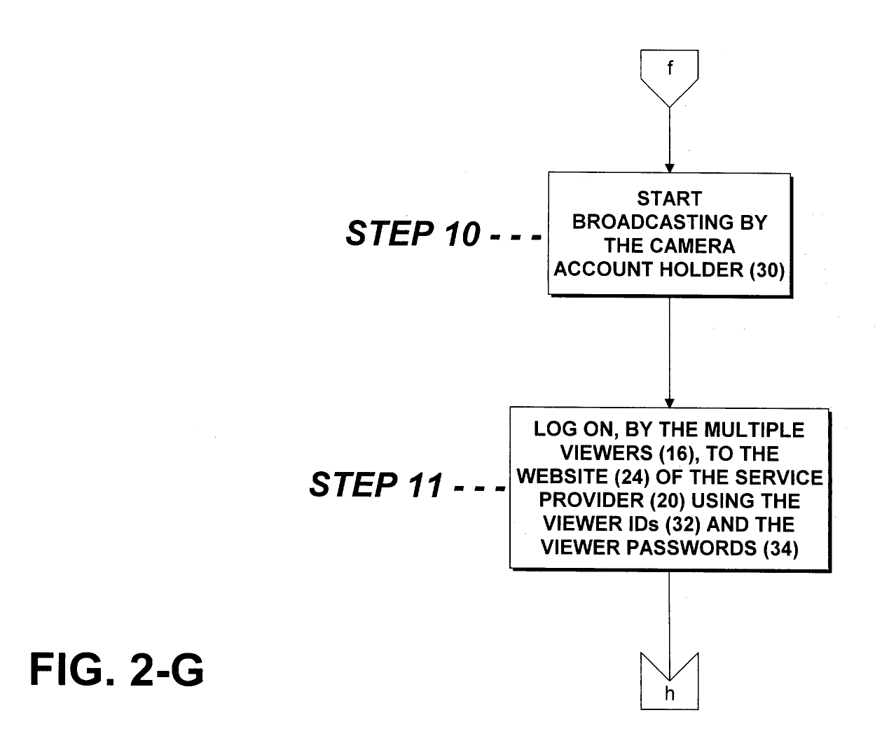

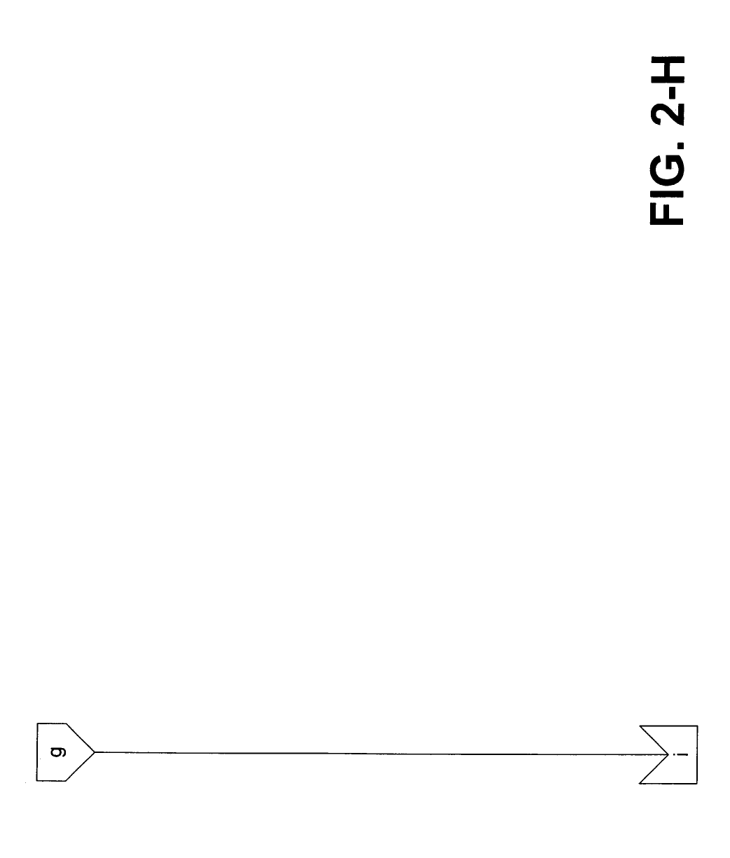

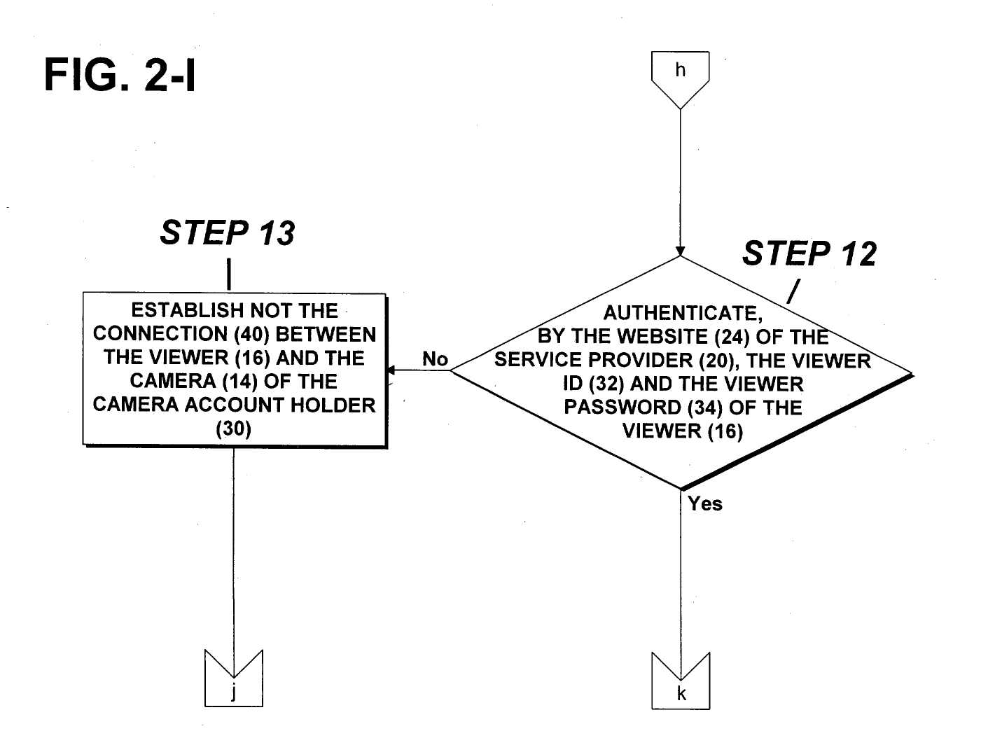

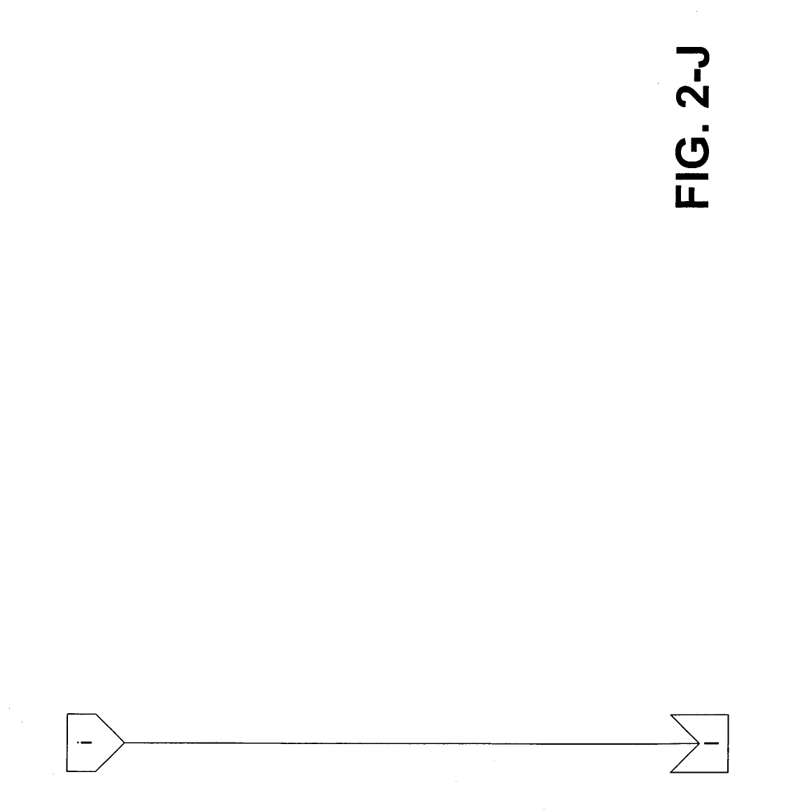

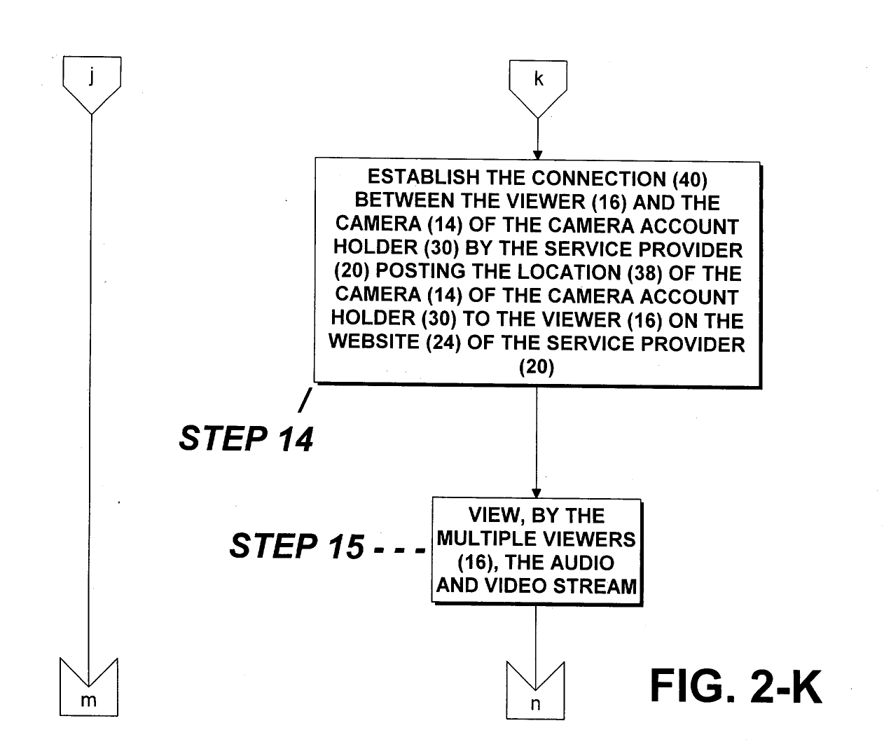

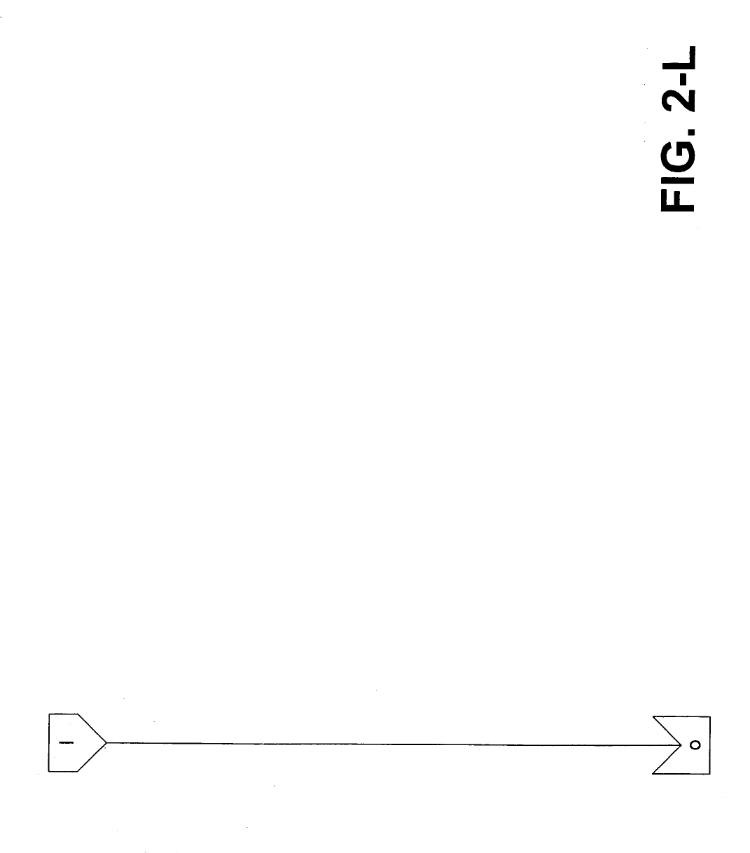

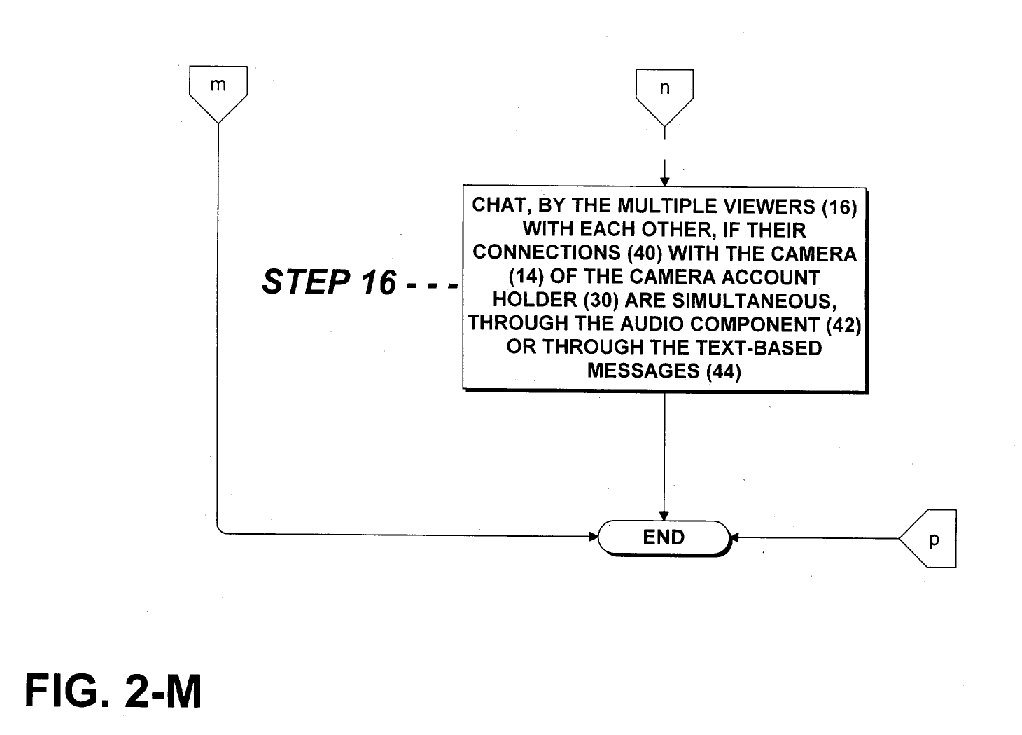

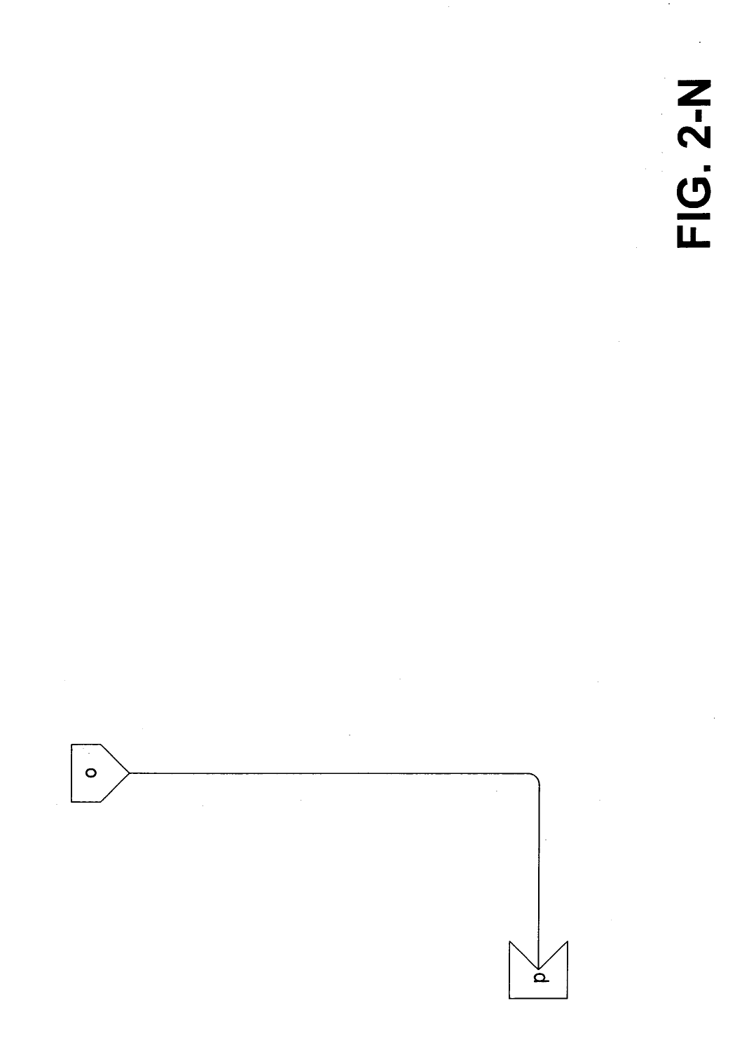

The method for allowing the user 12 to stream audio and video from the at least one camera 14 to the multiple viewers 16 simultaneously over the Internet utilizing the audio and video streaming platform 10 can best be seen in FIGS. 2A-2N, and as such, will be discussed with reference thereto.

STEP 1: Sign up, by the service provider 20 with the content provider 18, and create the partner account 26 between the service provider 20 and the content provider 18.

STEP 2: Receive, by the service provider 20 from the content provider 18, the instructions 25 on how to integrate the website 24 of the service provider 20 with the server 22 of the content provider 18.

STEP 3: Log on, by the user 12, to the website 24 of the service provider 20 to set up the camera account 28 and become the camera account holder 30.

STEP 4: Create, by the camera account holder 30, the viewer IDs 32 and the viewer passwords 34.

STEP 5: Provide, by the camera account holder 30 to the multiple viewers 16, the viewer IDs 32 and the viewer passwords 34.

STEP 6: Use, by the camera account holder 30, the software 36 to connect to the website 24 of the service provider 20.

STEP 7: Authenticate, by the website 24 of the service provider 20, the camera account holder 30.

STEP 8: Accept not, from the camera account holder 30 by the service provider 20, the location 38 of the camera 14 of the camera account holder 30, if STEP 7 is not authenticated.

STEP 9: Accept, from the camera account holder 30 by the service provider 20, the location 38 of the camera 14 of the camera account holder 30, if STEP 7 is authenticated.

STEP 10: Start broadcasting by the camera account holder 30.

STEP 11: Log on, by the multiple viewers 16, to the website 24 of the service provider 20 using the viewer IDs 32 and the viewer passwords 34.

STEP 12: Authenticate, by the website 24 of the service provider 20, the viewer ID 32 and the viewer password 34 of the viewer 16.

STEP 13: Establish not the connection 40 between the viewer 16 and the camera 14 of the camera account holder 30, if STEP 12 is not authenticated.

STEP 14: Establish the connection 40 between the viewer 16 and the camera 14 of the camera account holder 30 by the service provider 20 posting the location 38 of the camera 14 of the camera account holder 30 to the viewer 16 on the website 24 of the service provider 20, if STEP 12 is authenticated.

STEP 15: View, by the multiple viewers 16, the audio and video stream.

STEP 16: Chat, by the multiple viewers 16 with each other, if their connections 40 with the camera 14 of the camera account holder 30 are simultaneous, through the audio component 42 or through the text-based messages 44, while simultaneously viewing.

### EXAMPLE I

A business (service provider 20) has several day-care centers (user 12) as its customers. A growing wish of parents (viewer 16) who leave their children at a day-care center (user 12) is to be able to watch live video of their children to make sure that they are being handled properly. With the help of the content provider 18, the business (service provider 20) is able to offer live video streaming services to each of its day-care centers (user 20). The business (service provider 20) allows a day-care center (user 12) to sign up with it and then allows the day-care center (user 12) to offer live video service to its parents (viewer 16). The business (service provider 20) is free to charge any amount to the day-care center (user 12) and the day-care center (user 12) can charge any amount to the parent (viewer 16). It's entirely up to the business (service provider 20) and the day-care center (user 12) and between the day-care center (user 12) and the parent (viewer 16) as to how they want to handle the cost and fee among them. After signing up with the business (service provider 20), the day care center (user 12) has one or more cameras 14 connected up with a PC on its site. The content provider 18 authenticates each camera 14 before the camera 14 is allowed to broadcast over the Internet. Once authenticated, the camera 14 at the day-care center (user 12) starts streaming over the Internet. Each parent (viewer 16) is provided with a viewer account and signs on via the website 24 of the business (service provider 20). Once a parent (viewer 16) signs on, he/she is able to view the live streaming of their children at the day-care center (user 12). The whole experience of the parent (viewer 16) and the day-care center (user 12) is completely transparent of the content provider 18.

### EXAMPLE II

Wireless data service providers like AT&T, Sprint, T-Mobile, Verizon, and Cingular (service provider 20) can offer live video broadcast that can be viewed on a handheld or a cell phone equipped with a browser. The wireless data provider (service provider 20) integrates the software 36 of the content provider 18 into their existing web infrastructure. Since the software 36 of the content provider 18 uses the latest state of art technology called Web Services, integration disparate infrastructure is very simple.

Web Services are the fundamental building block to distributed computing on the Internet. Web Services use XML structures for communication between servers and sending data back and forth. SOAP (simple object access protocol) is a special standard of XML, specially developed for Web Service data exchange. XML and SOAP are specially formatted data independent of any programming language. Because of language independence, any scripting and programming language like php, jsp, asp, or .net can be used to develop a partner site (website 24 of service provider 20) and access the Web Services of the content provider 18.

Once the software 36 of the content provider 18 has been integrated into the service provider's site (website 24 of service provider 20), a wireless subscriber (user 12) can install a camera 14 on its computer and connect to the wireless service provider site (website 24 of service provider 20) using the software 36 of the content provider 18. Once logged on, any viewer 16 with a browser-equipped cell phone will be able to view the live images on their cell phones. This will be a new and exciting addition to current wireless services and will help a wireless data service provider (service provider 20) attract new customers.

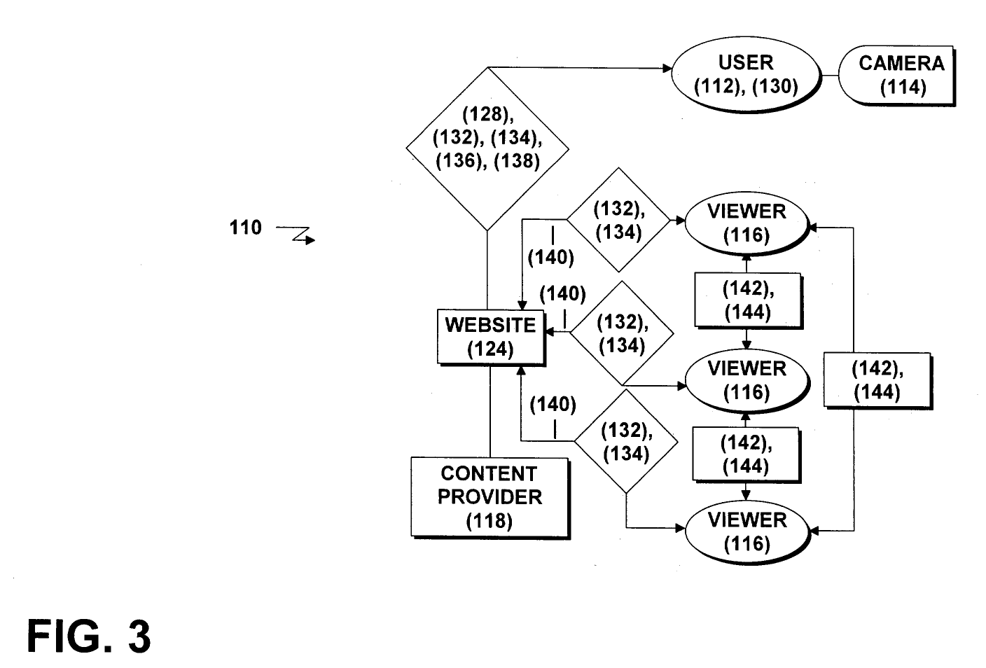

A second embodiment of the audio and video streaming platform 110 of the present invention for allowing a user 112 to stream audio and video from at least one camera 114 to multiple viewers 116 simultaneously over the Internet can best be seen in FIG. 3, which is a diagrammatic system diagram of a second embodiment of the audio and video streaming platform of the present invention, and as such, will be discussed with reference thereto.

The second embodiment of the audio and video streaming platform 110 is similar to the first embodiment of the audio and video streaming platform 10, except that a user 112 and multiple viewers 116 deal directly with a content provider 118, eliminating the service provider 20.

The audio and video streaming platform 110 comprises the content provider 118 that has a website 124.

The content provider 118 allows the user 112 to stream audio and video from the at least one camera 114 to the multiple viewers 116 simultaneously over the Internet through the website 124 of the content provider 118 so as to form an audio and video streaming service in response to the user 112 setting up a camera account 128 therewith and becoming a camera account holder 130.

The camera account 128 of the user 112 is set up on the website 124 of the content provider 118 making the user 112 the camera account holder 130 who creates viewer IDs 132 and viewer passwords 134 and provides them to the multiple viewers 116.

The camera account holder 130 uses software 136 to connect to the website 124 of the content provider 118. The website 124 of the content provider 118 authenticates the camera account holder 130 and does not accept from the camera account holder 130 a location 138 of the camera 114 of the camera account holder 130 if the camera account holder 130 is not authenticated, but does accept from the camera account holder 130 the location 138 of the camera 114 of the camera account holder 130 and allows the camera account holder 130 to start broadcasting if the camera account holder 130 is authenticated.

The multiple viewers 116 log on to the website 124 of the content provider 118 using the viewer IDs 132 and the viewer passwords 134. The website 124 of the content provider 118 authenticates the viewer ID 132 and the viewer password 134 of the viewer 116 and does not establish a connection 140 between the viewer 116 and the camera 114 of the camera account holder 130 if the viewer ID 132 and the viewer password 134 are not authenticated, but does establish the connection 140 between the viewer 116 and the camera 114 of the camera account holder 130 by the content provider 118 posting the location 138 of the camera 114 of the camera account holder 130 to the viewer 116 on the website 124 of the content provider 118 and allowing the viewer 116 to view the streaming audio and video if the viewer ID 132 and the viewer password 134 are authenticated.

The multiple viewers 116 chat with each other, if their connections 140 with the camera 114 of the camera account holder 130 are simultaneous, through an audio component 142 or through text-based messages 144, while simultaneously viewing.

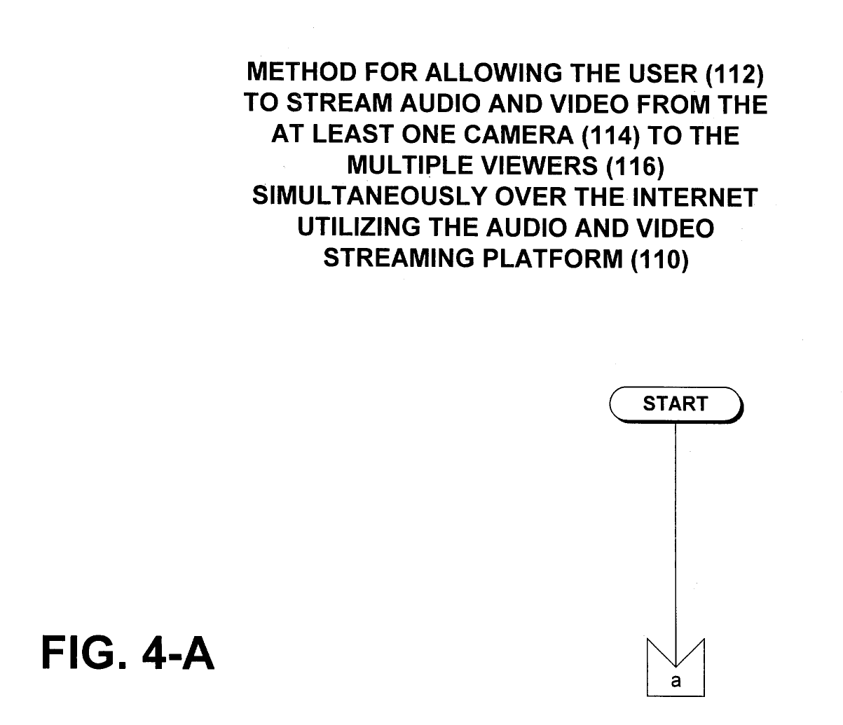

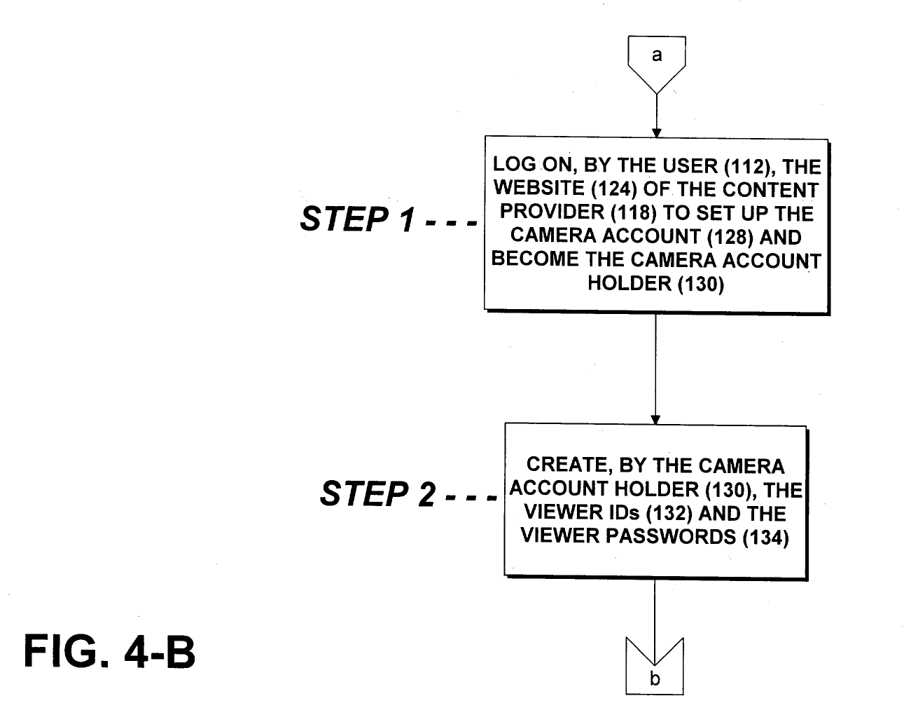

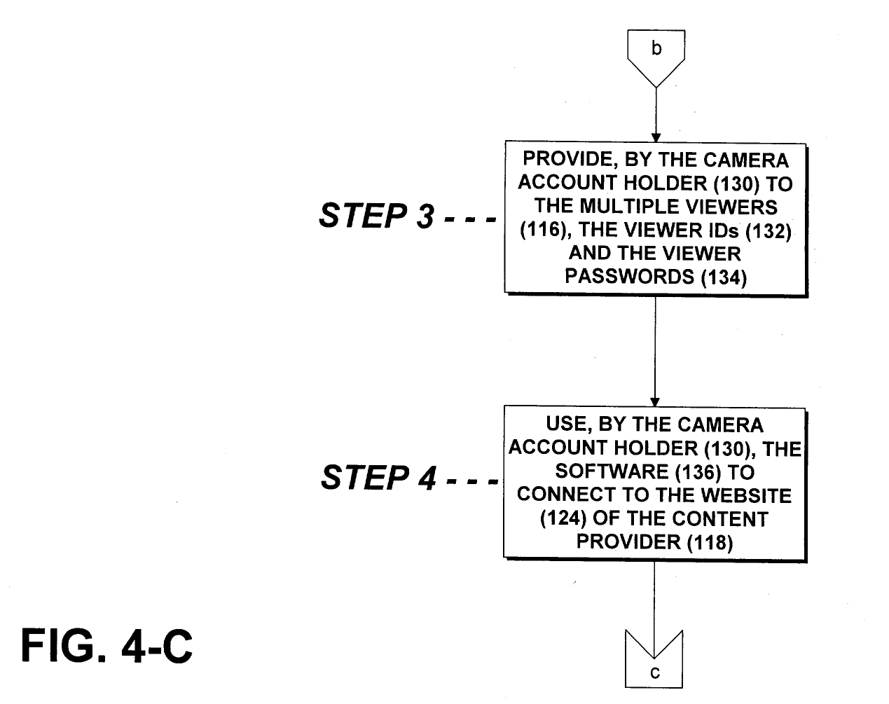

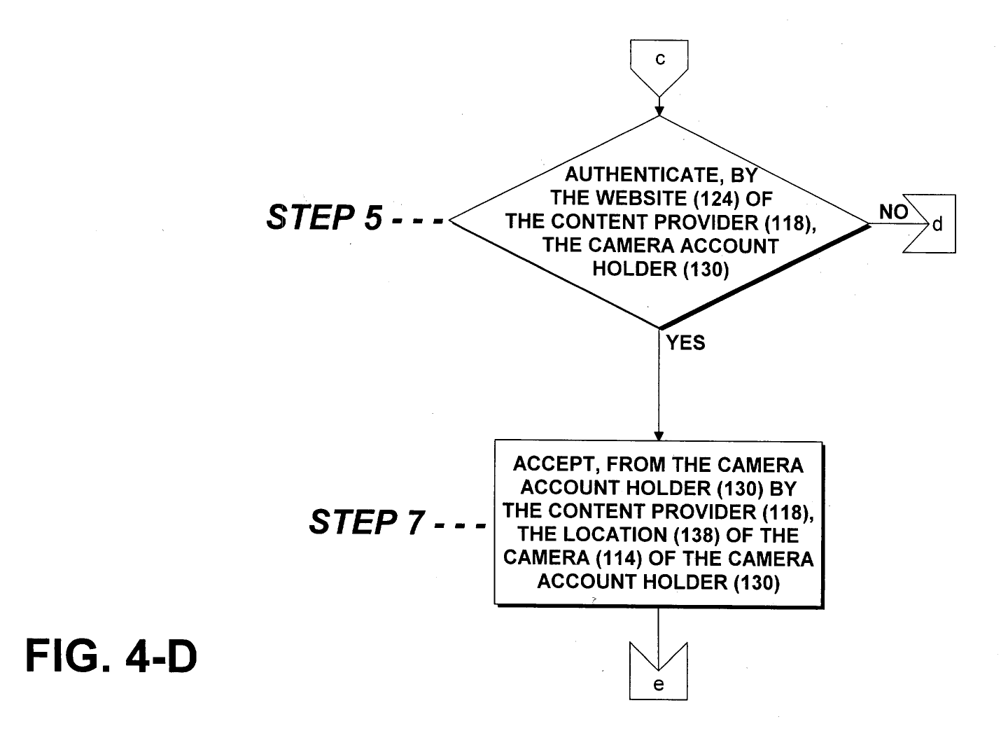

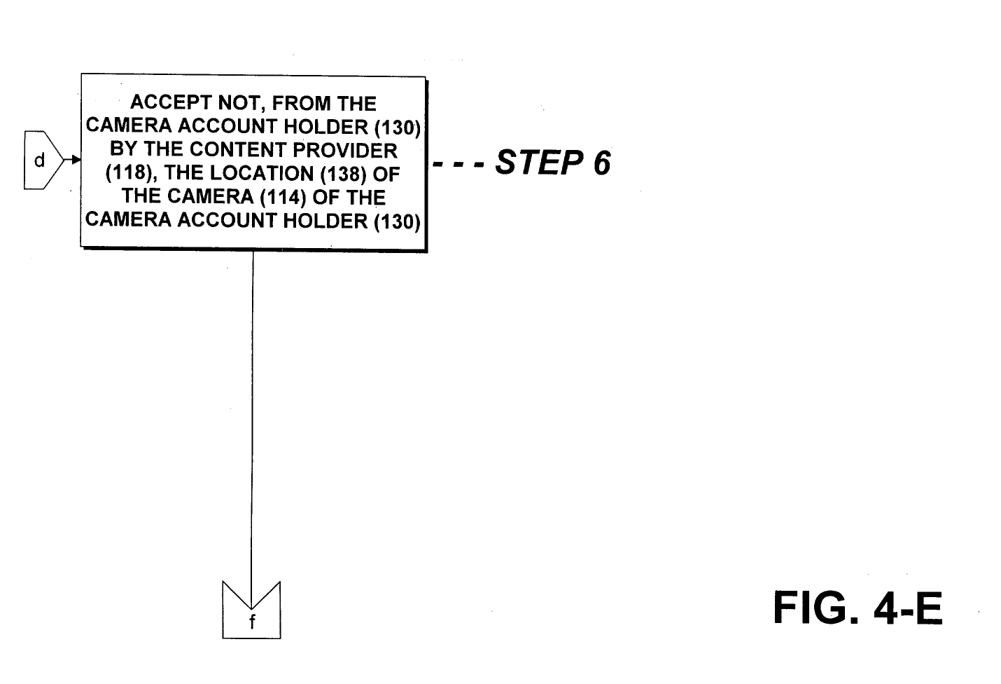

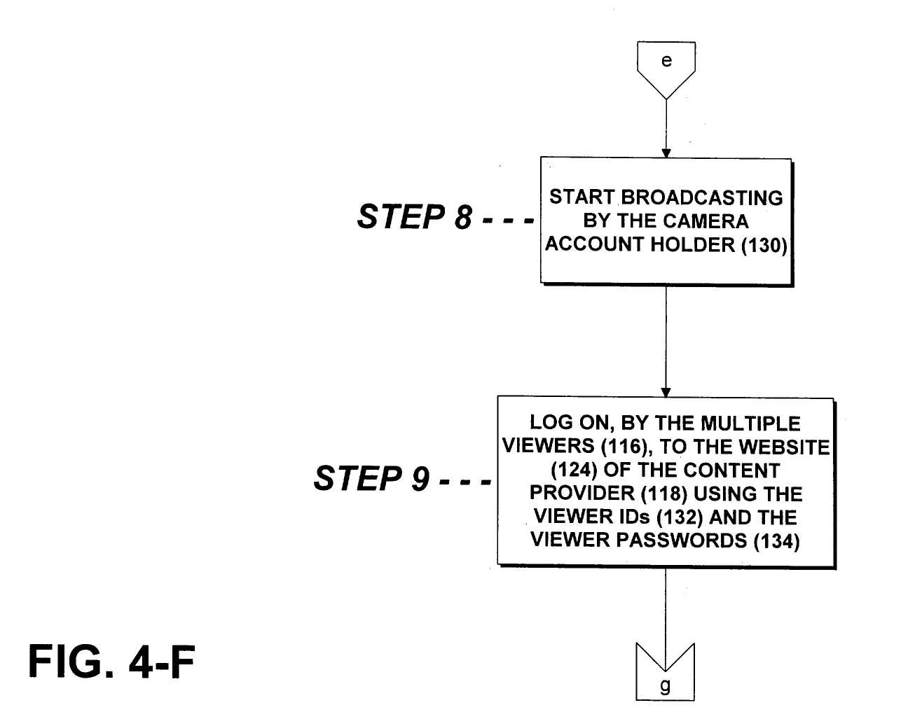

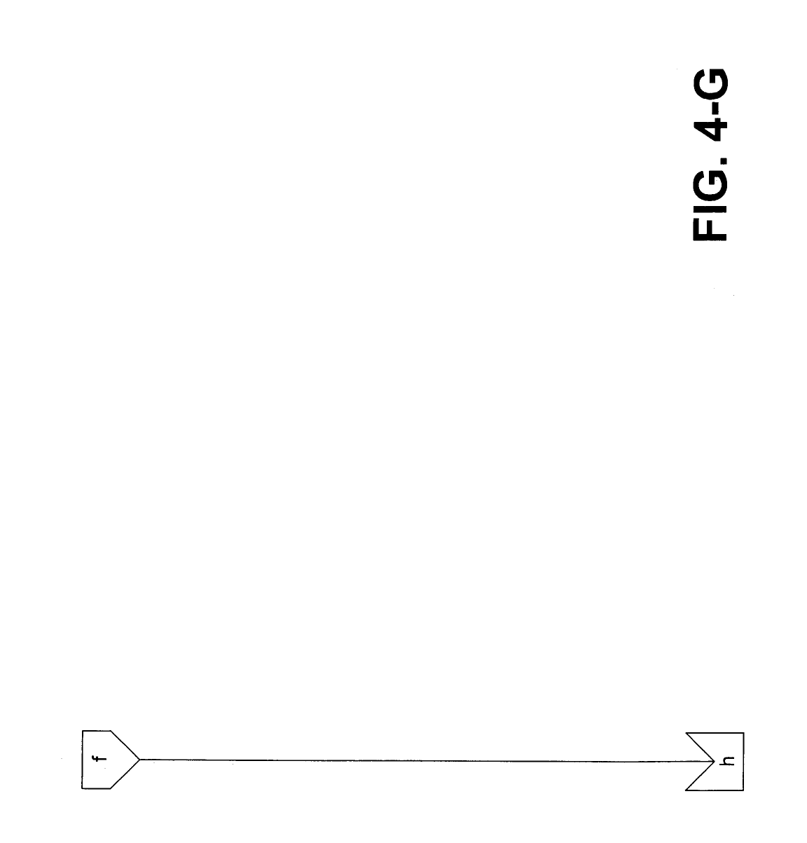

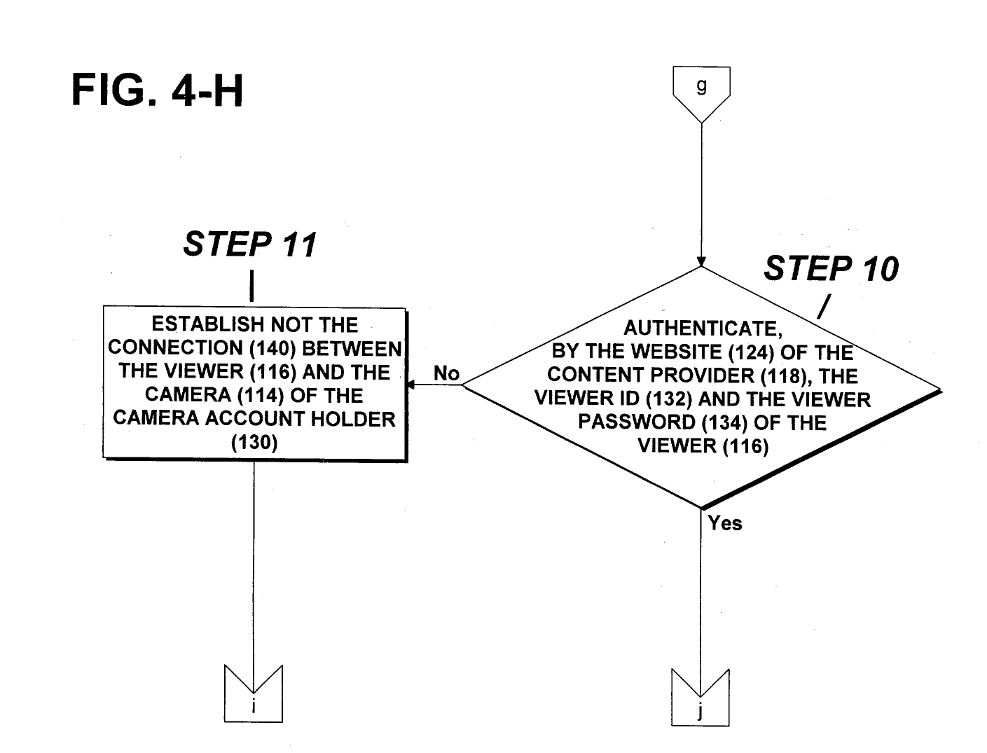

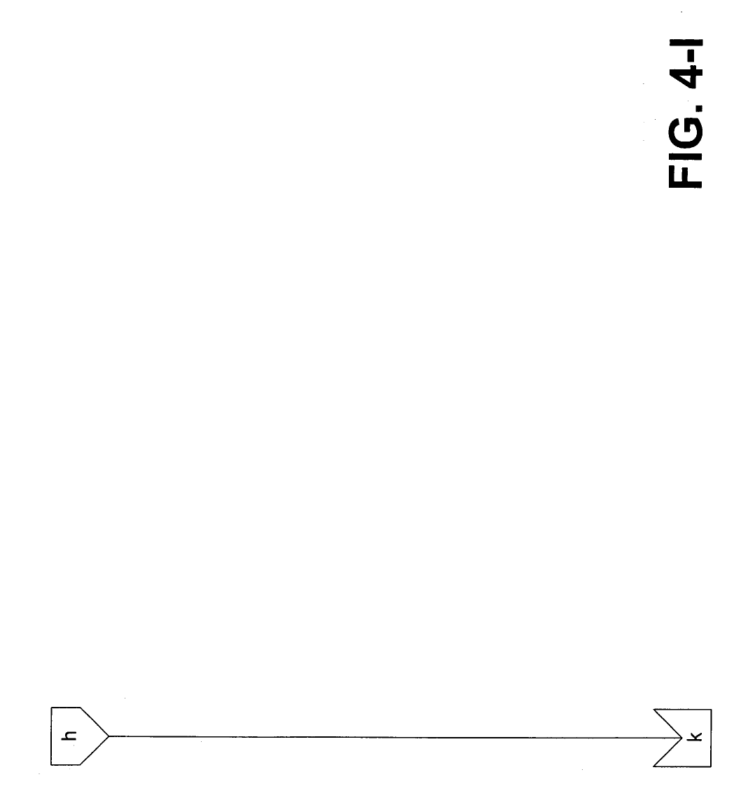

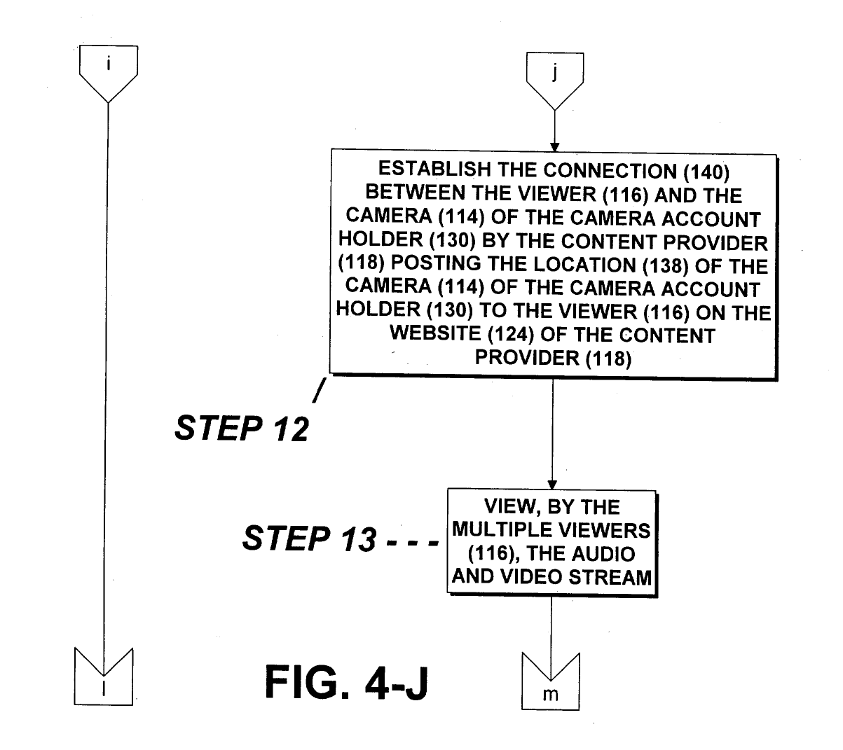

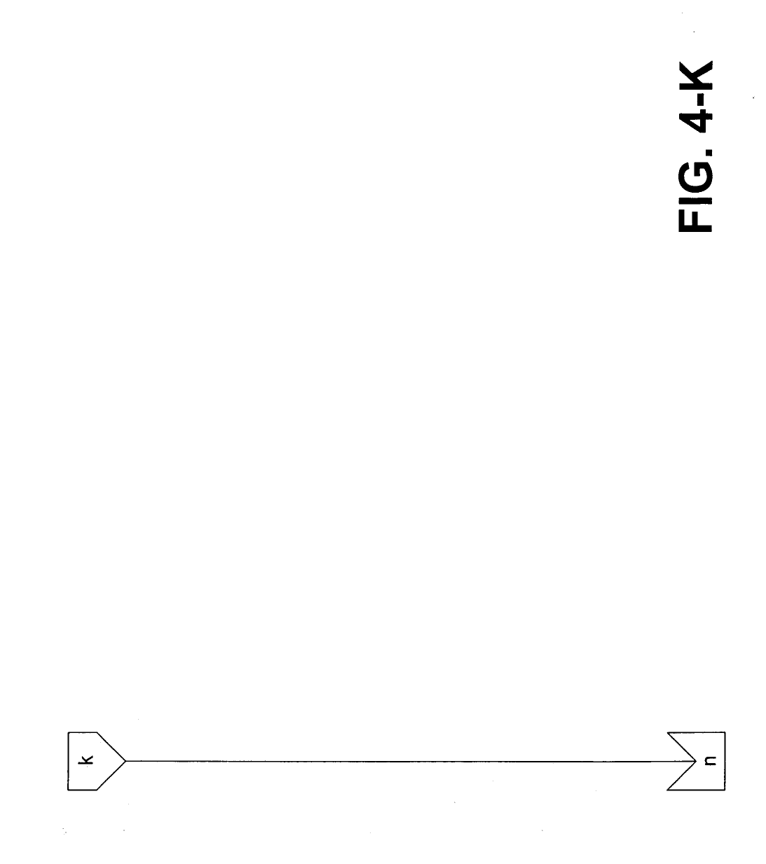

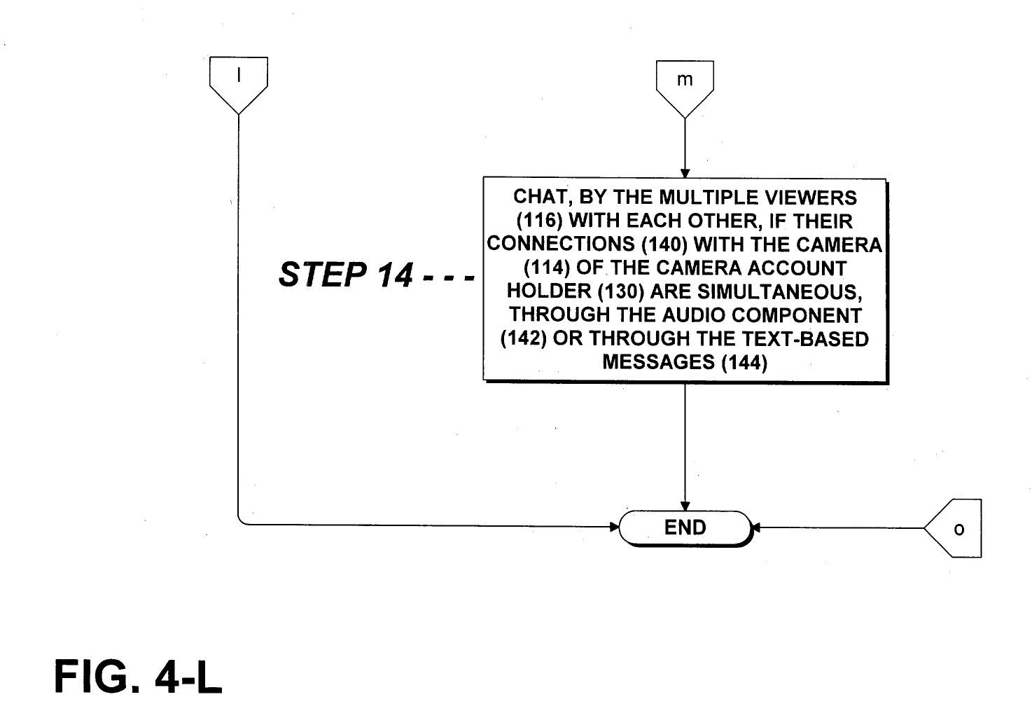

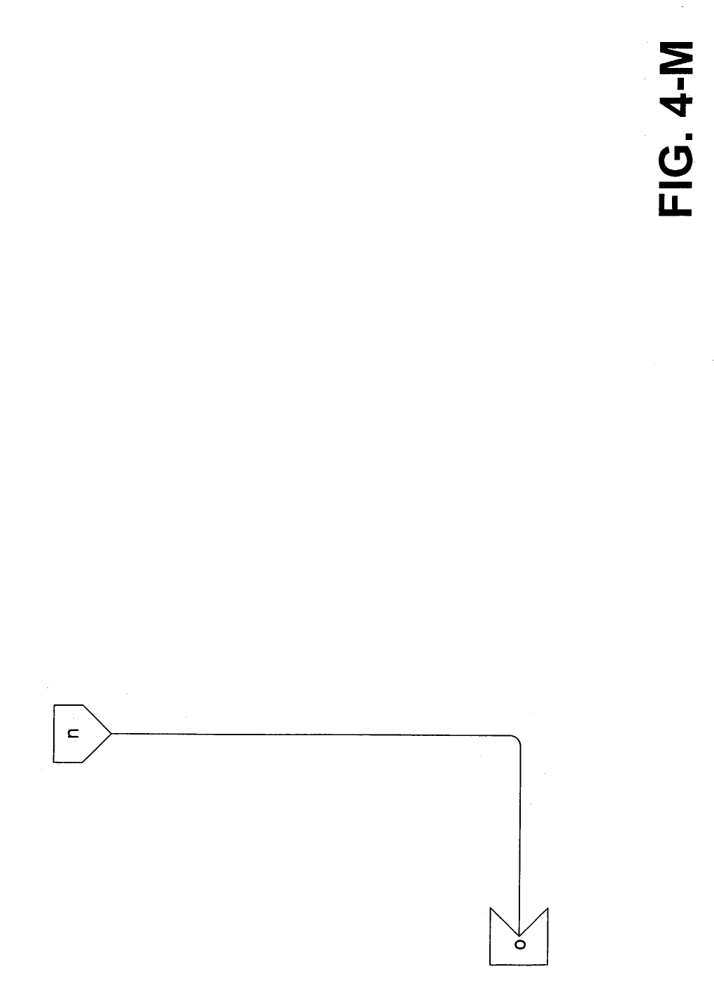

The method for allowing the user 112 to stream audio and video from the at least one camera 114 to the multiple viewers 116 simultaneously over the Internet utilizing the audio and video streaming platform 110 can best be seen in FIGS. 4A-4M, and as such, will be discussed with reference thereto.

STEP 1: Log on, by the user 112, the website 124 of the content provider 118 to set up the camera account 128 and become the camera account holder 130.

STEP 2: Create, by the camera account holder 130, the viewer IDs 132 and the viewer passwords 134.

STEP 3: Provide, by the camera account holder 130 to the multiple viewers 116, the viewer IDs 132 and the viewer passwords 134.

STEP 4: Use, by the camera account holder 130, the software 136 to connect to the website 124 of the content provider 118.

STEP 5: Authenticate, by the website 124 of the content provider 118, the camera account holder 130.

STEP 6: Accept not, from the camera account holder 130 by the content provider 118, the location 138 of the camera 114 of the camera account holder 130, if STEP 5 is not authenticated.

STEP 7: Accept, from the camera account holder 130 by the content provider 118, the location 138 of the camera 114 of the camera account holder 130, if STEP 5 is authenticated.

STEP 8: Start broadcasting by the camera account holder 130.

STEP 9: Log on, by the multiple viewers 116, to the website 124 of the content provider 118 using the viewer IDs 132 and the viewer passwords 134.

STEP 10: Authenticate, by the website 124 of the content provider 118, the viewer ID 132 and the viewer password 134 of the viewer 116.

STEP 11: Establish not the connection 140 between the viewer 116 and the camera 114 of the camera account holder 130, if STEP 10 is not authenticated.

STEP 12: Establish the connection 140 between the viewer 116 and the camera 114 of the camera account holder 130 by the content provider 118 posting the location 138 of the camera 114 of the camera account holder 130 to the viewer 116 on the website 124 of the content provider 118, if STEP 10 is authenticated.

STEP 13: View, by the multiple viewers 116, the audio and video stream.

STEP 14: Chat, by the multiple viewers 116 with each other, if their connections 140 with the camera 114 of the camera account holder 130 are simultaneous, through the audio component 142 or through the text-based messages 144, while simultaneously viewing.

It will be understood that each of the elements described above, or two or more together, may also find a useful application in other types of constructions differing from the types described above.

While the invention has been illustrated and described as embodied in a video streaming platform for allowing a user to stream audio and video from at least one camera to multiple viewers simultaneously over the Internet, however, it is not limited to the details shown, since it will be understood that various omissions, modifications, substitutions and changes in the forms and details of the device illustrated and its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute characteristics of the generic or specific aspects of this invention.

The invention claimed is:

1. An audio and video streaming platform for allowing a user to stream audio and video from at least one camera to multiple viewers simultaneously over the Internet, said platform comprising:
a) a content provider; and
b) a service provider;
wherein said content provider has a server;
wherein said server of said content provider allows streaming of audio and video from at least one camera to multiple viewers simultaneously over the Internet;
wherein said service provider has a website;
wherein said content provider delivers instructions to said service provider on how to integrate said website of said service provider with said server of said content provider in response to said service provider signing up with said content provider and creating a partner account therewith;
wherein said service provider allows the user to stream audio and video from the at least one camera to the multiple viewers simultaneously over the Internet through the website of the service provider so as to form an audio and video streaming service in response to the user setting up a camera account therewith and becoming a camera account holder, once said service provider has been integrated with said server of said content provider; and
wherein said service provider is integrated with said server of said content provider in such a way so as to allow said service provider to offer said audio and video streaming service through said website of said service provider that allows the user and the multiple viewers to get the impression that said audio and video streaming service is hosted from said website of said service provider when in reality it is hosted from said server of said content provider therefore making said audio and video streaming service transparent of said content provider.

2. The platform as defined in claim 1, wherein said server of said content provider uses low network bandwidth so as allow to the at least one user and the multiple viewers with slow Internet connections to use said platform without problems.

3. The platform as defined in claim 1, wherein said platform eliminates a need for said service provider to have a hosting infrastructure of expensive servers, writing complex programs, and bandwidth since said service provider is not hosting said platform.

4. The platform as defined in claim 1, wherein the at least one camera is associated with a PC of the user so as to form a cam server host machine.

5. The platform as defined in claim 4; further comprising software;
wherein said software is provided to said service provider from said content provider;
wherein said software is provided by said service provider to said cam server host machine.

6. The platform as defined in claim 1; further comprising viewer IDs and viewer passwords;
wherein said camera account of the user is set up on said website of said service provider making the user the camera account holder;
wherein said viewer IDs are created by said camera account holder;
wherein said viewer passwords are created by said camera account holder;
wherein said viewer IDs are provided by said camera account holder to the multiple viewers; and
wherein said viewer passwords are provided by said camera account holder to the multiple viewers.

7. The platform as defined in claim 5, wherein said software is used by said camera account holder to connect to said website of said service provider.

8. The platform as defined in claim 6, wherein said website of said service provider authenticates said camera account holder and does not accept from said camera account holder a location of the camera of said camera account holder if said camera account holder is not authenticated, but does accept from said camera account holder said location of the camera of said camera account holder and allows said camera account holder to start broadcasting if said camera account holder is authenticated.

9. The platform as defined in claim 6, wherein said viewer IDs and said viewer passwords are used by said multiple viewers to log on to said website of said service provider.

10. The platform as defined in claim 8, wherein said website of said service provider authenticates said viewer ID and said viewer password of each viewer and does not establish a connection between the viewer and the camera of said camera account holder if said viewer ID and said viewer password are not authenticated, but does establish said connection between the viewer and the camera of said camera account holder by said service provider posting said location of the camera of said camera account holder to the viewer on said website of said service provider and allowing each viewer to view said streaming audio and video if said viewer ID and said viewer password are authenticated.

11. The platform as defined in claim 10; further comprising one of an audio component and text-based messages;
wherein said one of said audio component and said text-based messages allow the multiple viewers to chat with each other if their connections with the camera of said camera account holder are simultaneous, while simultaneously viewing.

12. An audio and video streaming platform for allowing a user to stream audio and video from at least one camera to multiple viewers simultaneously over the Internet, said platform comprising:
a content provider;
wherein said content provider has a website; and
wherein said content provider allows the user to stream audio and video from the at least one camera to the multiple viewers simultaneously over the Internet through said website of said content provider so as to form an audio and video streaming service in response to the user setting up a camera account therewith and becoming a camera account holder.

13. The platform as defined in claim 12, wherein the at least one camera is associated with a PC of the user so as to form a cam server host machine.

14. The platform as defined in claim 13; further comprising software;
wherein said software is provided to said cam server host machine from said content provider.

15. The platform as defined in claim 12; further comprising viewer IDs and viewer passwords;
wherein said camera account of the user is set up on said website of said content provider making the user the camera account holder; and
wherein said viewer IDs are created by said camera account holder;
wherein said viewer passwords are created by said camera account holder;
wherein said viewer IDs are provided by said camera account holder to the multiple viewers; and
wherein said viewer passwords are provided by said camera account holder to the multiple viewers.

16. The platform as defined in claim 14, wherein said software is used by said camera account holder to connect to said website of said content provider.

17. The platform as defined in claim 15, wherein said website of said content provider authenticates said camera account holder and does not accept from said camera account holder a location of the camera of said camera account holder if said camera account holder is not authenticated, but does accept from said camera account holder said location of the camera of said camera account holder and allows said camera account holder to start broadcasting if said camera account holder is authenticated.

18. The platform as defined in claim 15, wherein said viewer IDs and said viewer passwords are used by said multiple viewers to log on to said website of said content provider.

19. The platform as defined in claim 17, wherein said website of said content provider authenticates said viewer ID and said viewer password of each viewer and does not establish a connection between the viewer and the camera of said camera account holder if said viewer ID and said viewer password are not authenticated, but does establish said connection between the viewer and the camera of said camera account holder by said content provider posting said location of the camera of the camera account holder to each viewer on said website of said content provider and allowing each viewer to view said streaming audio and video if said viewer ID and said viewer password are authenticated.

20. The platform as defined in claim 12; further comprising one of an audio component and text-based messages;
wherein said one of said audio component and said text-based messages allow the multiple viewers to chat with each other if their connections with the camera of said camera account holder are simultaneous, while simultaneously viewing.

21. A method for allowing a user to stream audio and video from at least one camera to multiple viewers simultaneously over the Internet utilizing an audio and video streaming platform, wherein said audio and video streaming platform includes a service provider having a website and a content provider having a server, said method comprising the steps of:
a) creating a partner account between the service provider and the content provider;
b) integrating the website of the service provider with the server of the content provider in such a way so as to allow said service provider to offer an audio and video streaming service through said website of said service provider that allows the user and the multiple viewers to get the impression that said audio and video streaming service is hosted from said website of said service provider when in reality it is hosted from said server of said content provider therefore making the audio and video streaming service transparent of said content provider;
c) setting up a camera account by the user on the website of the service provider so as to become a camera account holder;
d) accessing, by said camera account holder, said audio and video streaming service of said service provider;
e) starting to broadcast by the camera account holder on the website of the service provider; and
f) viewing by the multiple viewers the audio and video stream on the website of the service provider.

22. The method as defined in claim 21, wherein said creating step includes signing up by the service provider with the content provider and creating the partner account between the service provider and the content provider.

23. The method as defined in claim 21; further comprising the step of receiving, by the service provider from the content provider, instructions on how to integrate the website of the service provider with the server of the content provider.

24. The method as defined in claim 21, wherein said setting up step includes logging on, by the user, the website of the service provider to set up the camera account and become the camera account holder.

25. The method as defined in claim 21; further comprising the steps of:
a) creating by the camera account holder viewer IDs and viewer passwords; and
b) providing, by the camera account holder to the multiple viewers, the viewer IDs and the viewer passwords.

26. The method as defined in claim 21, wherein said starting to broadcast step includes the steps of:
a) using, by the camera account holder, software to connect to the website of the service provider;
b) authenticating, by the website of the service provider, the camera account holder;
c) accepting not, from the camera account holder by the service provider, a location of the camera of the camera account holder if said first authenticating step is not authenticated; and
d) accepting, from the camera account holder by the service provider, the location of the camera of the camera account holder and starting to broadcast by the camera account holder if said first authenticating step is authenticated.

27. The method as defined in claim 26, wherein said viewing step includes the steps of:
a) logging on, by the multiple viewers, to the website of the service provider using the viewer IDs and the viewer passwords;
b) authenticating, by the website of the service provider, the viewer ID and the viewer password of each viewer;
c) establishing not a connection between the viewer and the camera of the camera account holder if said second authenticating step is not authenticated; and
d) establishing the connection between the viewer and the camera of the camera account holder and viewing, by each viewer, the audio and video stream if said second authenticating step is authenticated.

28. The method as defined in claim 27, wherein said establishing step includes posting by the service provider the location of the camera of the camera account holder to the viewer on the website of the service provider.

29. The method as defined in claim 27; further comprising the step of chatting, by the multiple viewers with each other, if their connections with the camera of the camera account holder are simultaneous, while simultaneously viewing.

30. The method as defined in claim 29, wherein said chatting step includes chatting through one of an audio component and text-based messages.

31. A method for allowing a user to stream audio and video from at least one camera to multiple viewers simultaneously over the Internet utilizing an audio and video streaming platform, wherein said audio and video streaming platform includes a content provider having a website, said method comprising the steps of:
a) setting up a camera account by the user on the website of the content provider so as to become a camera account holder;
b) starting to broadcast by the camera account holder on the website of the content provider; and
c) viewing by the multiple viewers the audio and video stream on the website of the content provider.

32. The method as defined in claim 31, wherein said setting up step includes logging on, by the user, the website of the content provider to set up the camera account and become the camera account holder.

33. The method as defined in claim 31; further comprising the steps of:
a) creating by the camera account holder viewer IDs and viewer passwords; and
b) providing, by the camera account holder to the multiple viewers, the viewer IDs and the viewer passwords.

34. The method as defined in claim 33, wherein said starting to broadcast step includes the steps of:
a) using, by the camera account holder, software to connect to the website of the content provider;
b) authenticating, by the website of the content provider, the camera account holder;
c) accepting not, from the camera account holder by the content provider, a location of the camera of the camera account holder if said first authenticating step is not authenticated; and
d) accepting, from the camera account holder by the content provider, the location of the camera of the camera account holder and starting to broadcast by the camera account holder if said first authenticating step is authenticated.

35. The method as defined in claim 34, wherein said viewing step includes the steps of:
a) logging on, by the multiple viewers, to the website of the content provider using the viewer IDs and the viewer passwords;
b) authenticating, by the website of the content provider, the viewer ID and the viewer password of each viewer;
c) establishing not a connection between the viewer and the camera of the camera account holder if said second authenticating step is not authenticated; and
d) establishing the connection between the viewer and the camera of the camera account holder and viewing, by the each viewer, the audio and video stream if said second authenticating step is authenticated.

36. The method as defined in claim 35, wherein said establishing step includes posting by the content provider the location of the camera of the camera account holder to the viewer on the website of the content provider.

37. The method as defined in claim 31; further comprising the step of chatting, by the multiple viewers with each other, if their connections with the camera of the camera account holder are simultaneous, while simultaneously viewing.

38. The method as defined in claim 37, wherein said chatting step includes chatting through one of an audio component and text-based messages.
